(19) United States
(12) Patent Application Publication
(10) Pub. No.: US 2010/0312639 A1
(43) Pub. Date: Dec. 9, 2010

(54) SYSTEM AND METHOD FOR PRESENTING DIGITAL MEDIA TO AN END-USER

(76) Inventor: Tony Mastronardi, Montreal (CA)

Correspondence Address: Franz Bonsang;C/o Equinox Protection, 410-1500 Du College, St Laurent, QC, CA

(21) Appl. No.: 12/735,424

(22) PCT Filed: Jan. 16, 2008
(86) PCT No.: PCT/CA2008/000079

§ 371 Date: Jul. 15, 2010

(51) Int. Cl. G06Q 30/00

(52) U.S. Cl. 705/14.48; 705/14.49

(57) ABSTRACT

A system (10) and method (200) for presenting digital media for promotion thereof provides for presentation of promotional media elements (32) associated with advertisements (52) and campaigns (48) defined by promoters to users on end-user computers (20) by presentation of the promotional media elements (32) from a media provider (18) thereon. Presentation of the promotional media elements (32) is based upon advertisement parameters (66, 78, 92, 96, 100, 106, 108, 112, 114, 116, 172, 270, 280) defined for the advertisements (52) and campaigns (48) by the promoters. The promotional media elements (32) may be submitted by the promoter to the media providers (18) and may be proposed to end-users with greater or lesser degrees of prominence (233), also based upon advertisement parameters (66, 78, 92, 96, 100, 106, 108, 112, 114, 116, 172, 270, 280). Compensation for presentation of the promotional media elements (32) for advertisements (52) and campaigns (48) is also provided.

### FIELD OF THE INVENTION

The present invention is related to digital media distribution systems and methods, and is more particularly directed to a system and method for presenting digital media for promotion thereof to an end-user.

### BACKGROUND OF THE INVENTION

Digital media distribution systems and methods for distributing and presenting digital media over a network are well known in the art. For example, network media providers, such as I-Tunes™ offered by Apple™ Computer corporation of Cupertino, Calif., USA, offer systems and methods for distributing and presenting digital media elements, such as videos or musical works in machine-readable and presentable digital format, as digital media elements, to paying end-users. The media element is typically submitted, i.e. distributed, to the media provider by a promoter thereof, who wishes to sell the media element and/or a product or service associated therewith. The end-user may then download the media element from the media provider to the end-users' computers over a network, generally after having paid a fee for purchase of the media element, a part of which may be paid to the promoter. Additionally, the systems and methods employed by such media providers generally allow end-users to search the musical works offered by the media provider to find a desired media element and sample at least a portion thereof prior to purchasing. Thus, the promoter is able to distribute and present the media element to the end-user, via the media provider.

Another example of systems and methods for distributing and presenting digital media, are media providers which operate and/or provide digital jukeboxes or kiosks. Such kiosks are often available in public spaces and permit presentation of digital media elements to end-users, the kiosks and jukeboxes serving as end-user computers. Such digital media elements generally consist of musical works, images, and videos or films in digital format. Generally, users of the digital jukeboxes and kiosks, which are typically connected to the media provider by a network, may browse a selection of digital media elements accessible from the media provider thereupon and, upon payment of a user fee at the kiosk or jukebox, select a digital media element which is then presented on the jukebox or kiosk. Once again, the digital media element is generally distributed to the media provider by a promoter thereof.

Systems and methods such as those described above may be, however, of limited effectiveness for distributing promoted media elements such as, for example, musical works, texts, videos, and movies which a promoter wishes to promote and which may be unknown to a large number of end-users, for example new musical works, videos, films, or movies or musical works, videos, and films featuring new artists. In such cases, as the musical works, videos, films, and/or artists are unknown, end-users may not enter criteria when searching or browsing on the end-user computer that will present the promoted media element as an option for presentation or distribution to the end-user on the end-user computer. Such shortcomings are common for systems such as I-tunes™ and Adwords™ by Google™ Corporation of California which, typically, require entry of keywords by a user to provide a basis for generating promotional media elements and advertisements for presentation to the user and which return promotional media elements and advertisements based on such keywords. Also, from a promoter perspective, such systems do not necessarily allow promoters to target media elements and advertisements for end-users based on past selection patterns, which might include, for example, payment by end-users for presentation or distribution of specific media elements or media elements having certain characteristics.

Further, for conventional digital media presentation systems and methods, if the end-user has little knowledge of the promoted media element, the end-user may be unwilling to pay a user fee for presentation of purchase thereof, even if a partial sample of the promotional media element is provided. Additionally, end-users may hesitate to select certain types of promoted media elements, such as audio/video advertisements, image advertisements, text advertisements, or audio advertisements which promote a product or service.

Accordingly, there is a need for an improved system and method for presenting digital media for promotion thereof to an end-user.

### SUMMARY OF THE INVENTION

It is therefore a general object of the present invention to provide an improved system and method for presenting digital media for promotion thereof to an end-user.

An advantage of the present invention is that the system and method provided thereby provides an increased likelihood that a promotional media element will be presented to a user.

Another advantage of the present invention is that the system and method provided thereby allows an end-user to select a promotional digital media element desired for presentation.

A further advantage of the present invention is that the system and method provided thereby allows targeting of promotional digital media elements for presentation on an end-user computer, based upon campaign parameters definable by a promoter.

Still another advantage of the present invention is that the system and method provided thereby provides an estimate of presentations of the promotional media element based upon campaign parameters definable by a promoter.

Another advantage of the present invention is that the system and method provided thereby can match the campaign parameters for the media elements to a usage history of the end-user computer.

According to a first aspect of the present invention, there is provided a system for presenting digital media for promotion thereof to an end-user, the system comprising:
a promoter interface for defining at least one advertisement having at least one respective advertisement parameter and designating, from at least one media element of the digital media, a respective promotional media element associated with the advertisement;
at least one end-user interface communicably coupled to a respective end-user computer accessible by the end-user for detecting at least one predefined event and presenting, in response thereto, the respective promotional media element of at least one presentable advertisement of the at least one advertisement; and
a business module communicably coupled to the promoter interface and to the at least one end user interface for identifying, upon detection of the predefined event and based upon the at least one respective advertisement parameter, the at least one presentable advertisement, thereby promoting the promotional media element to the end-user.

According to a second aspect of the present invention, there is provided a method for presenting digital media to an end-user for promotion thereof to the end user, the method comprising the steps of:
presenting a promoter interface for defining at least one advertisement having at least one respective advertisement parameter, including a respective advertisement budget therefor, and a respective promotional media element associated therewith, the respective promotional media element being a media element of the digital media;
based on the at least one advertisement parameter, identifying, in response to at least one predefined event, at least one the advertisement as a presentable advertisement;
presenting on an end-user computer, through an end-user interface, at least one of the respective promotional media element of the presentable advertisement and a selectable reference to the presentable promotional media element of the presentable advertisement by which the end-user may select the promotional media element of the presentable advertisement for presentation on the end-user computer;

and
collecting, in accordance with the respective advertisement budget for the advertisement for which the respective promotional media element is presented, a compensation when the presentable promotional media element is presented on the end-user computer.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a block diagram showing hardware elements of a system for presenting digital media for promotion thereof to a an end-user in accordance with an embodiment of the present invention;

FIG. 2 is a clock diagram showing the software and logical elements of the embodiment shown in FIG. 1;

FIG. 3 is a is a data schema showing the data elements for the embodiment shown in FIG. 1;

FIG. 4 is a flow chart showing a method for presenting digital media for promotion thereof to an end-user in accordance with an embodiment of the present invention;

FIG. 5 is a flow chart showing the steps for defining an advertisement for the method shown in FIG. 4;

FIG. 6 is a flow chart showing the steps for identifying a presentable media element for the method shown in FIG. 4;

FIG. 7 is a table diagram showing scores and ranks generated by the system shown in FIG. 1 and the method shown in FIG. 4; and

FIG. 8 is a depiction of a selection screen generated by the system of FIG. 1 and the method of FIG. 4.

### DETAILED DESCRIPTION OF THE PREFERRED EMBODIMENTS

With reference to the annexed drawings the preferred embodiments of the present invention will be herein described for indicative purpose and by no means as of limitation.

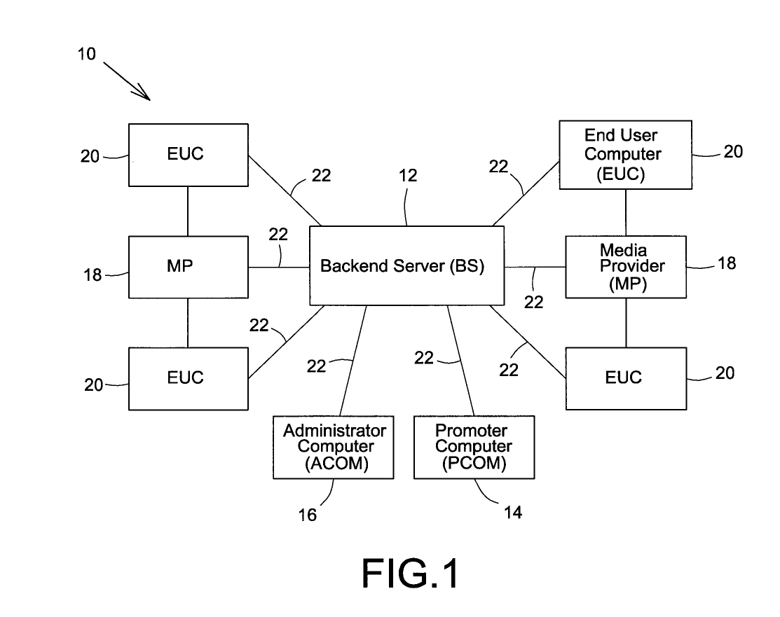

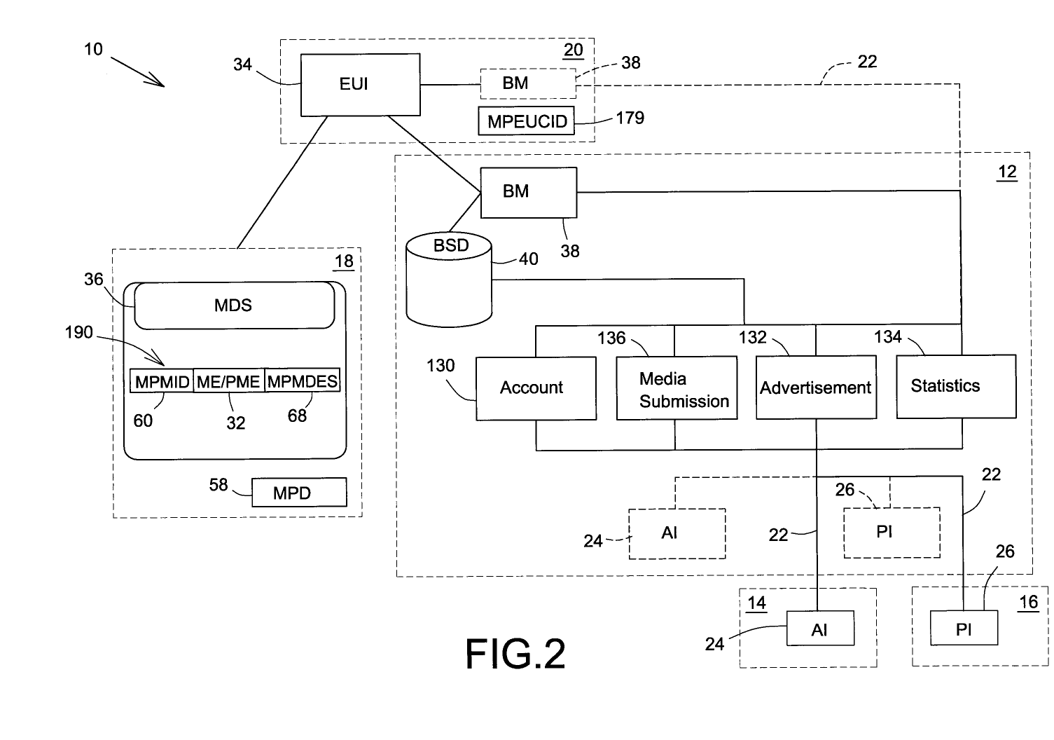

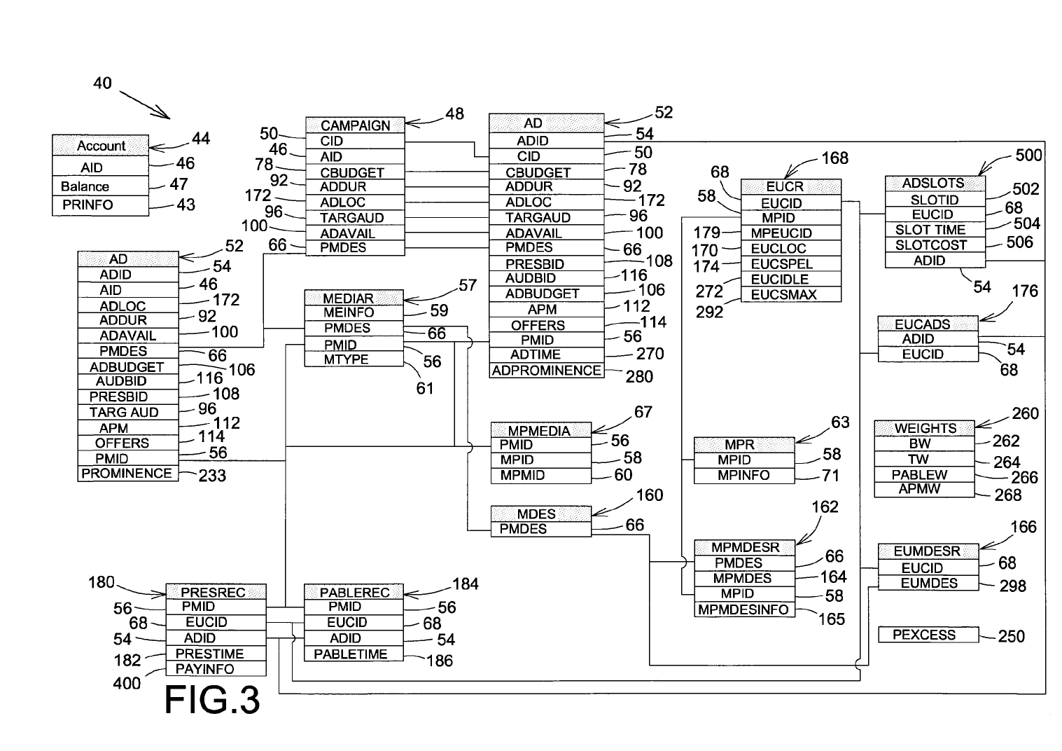

Reference is now made to FIGS. 1, 2, and 3. FIG. 1 is a block diagram of the hardware elements of a system, shown generally as 10, for distributing promotional digital media in accordance with an embodiment of the present invention. FIG. 2 is a block diagram of the logical elements, which may include hardware and software, for the system 10. FIG. 3 is a data scheme showing data elements used by system 10.

As best shown in FIGS. 1 and 2, the system 10 consists of a backend server computer (BS) 12 which provides the administrative services and administrative interfaces (Al) 24 to administrative users, referred to hereinafter as administrators, for administration of the system 10, as well as promoter services and promoter interfaces (PI) 26 to promoter users, referred to hereinafter as promoters, for defining advertisements (ADS) 52 and campaigns 48 of advertisements 52 which are associated with, i.e. by reference to, respective promotional digital media elements 32. The promoter interface 26 is generally resident on, and accessed from, at least one respective promoter computer (PCOM) 14 for the promoter and which is communicably coupled to the backend server 12. Similarly, the administrator interface 24 is generally resident on, and accessed from, at least one administrator computer (ACOM) 16 for the administrator and which is communicably coupled to the backend server 12.

The backend server 12 is also communicably coupled to at least one media provider (MP) 18, which is a computer typically, but not necessarily, operated by a third party media provider service, i.e. other than the operator of the backend server 12. The media provider 18 provides all digital media, hereinafter referred to as media elements (ME) 32, including promotional media elements (PME) 32 associated with respective advertisements 52 and campaigns 48 defined by promoters, to at least one respective end-user computer (EUC) 20 therefor. Each respective end-user computer 20 is communicably coupled to the respective media provider 18 therefor. To communicate with each end-user computer 20, the backend server 12 may be communicably coupled directly thereto, notably to an end-user interface (EUI) 34 resident thereupon and which is communicably coupled to the media provider 18. Alternatively, the backend server 12 may communicate with the end-user computer 20 or end-user interface 34 indirectly via the media provider 18. The end-user computer 20 presents the media elements 32, including promotional media elements 32 in association with advertisements 52 and which are generally presented by the end-user interface 34, to end-users thereof. End-user inputs received on the end-user computer 20 relating to advertisements 52 and campaigns 48 are generally received by the end-user interface 34, which also monitors activity on the end-user computer 20 for gathering statistics for all media elements 32 presented thereon.

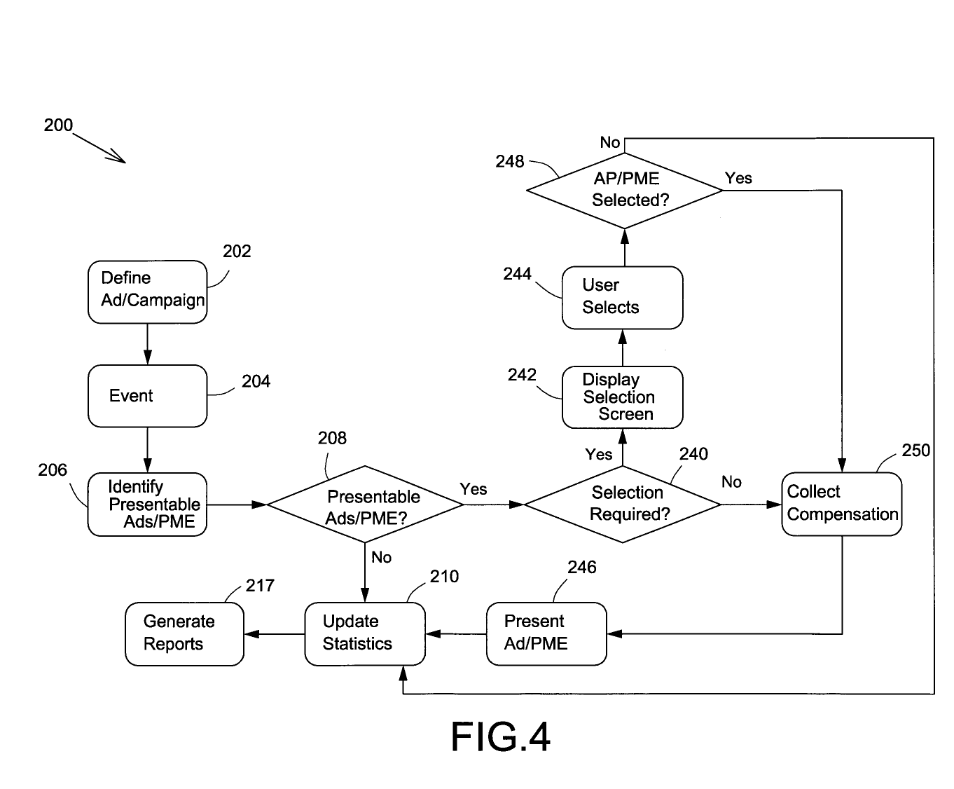

In general, and referring additionally now to FIG. 4, the end-user interface 34 monitors the end-user computer 20 for occurrence of a predefined event 204 on the end-user computer 20. Upon occurrence of the predefined event 204, the business module (BM) 38 identifies, if possible, at least one advertisement 52, having a respective promotional media element 32 associated therewith, as a presentable advertisement for potential presentation by the end-user interface 34 on the end-user computer 20. Depending on the type of end-user computer 20 and the type of promotional media element 32 associated with the advertisement 52, the end-user interface 34 may then either provide selection of one of the respective promotional media elements 32 for the presentable advertisements 52 or may simply present the respective promotional media element 32 of one presentable advertisement 52. When a selection is provided among promotional media elements 32, the end-user may select an action, such as presentation of the promotional media element 32, for the presentable advertisement 52.

It should be noted that, for the purposes of this description, the term “communicably coupled” indicates that a hardware element, such as a computer, a software element, such as software module, or combination thereof may exchange data with another hardware element, software element, or combination thereof. Preferably, for the embodiment shown, the backend server 12, promoter computer 14, administrator computer 16, media provider 18, and end-user computer 20 are communicably coupled, wirelessly or on a wireline basis, by a network 22, either private or public. Such a network 22 could include, for example, the Internet. It should further be noted that that the administrator computer 16 and the backend server 12 could be integrated into one computer, namely the backend server 12, in which case the administrator interface 24 would be resident directly on the backend server 12. Similarly, the backend server 12 could also provide all the services of the promoter computer 14. In such a case, for example when the promoter user represents the same entity as the operator of the backend server 12, the promoter interface 26 could be resident on the backend server 12. The backend server 12 could also host the media provider 18 and provide all the services thereof, for example when the backend server 12 and media provider 18 are operated by the same entity or user, in which case the media elements 32 could also be stored on the backend server 12.

Further, and again for the purposes of this description, the term “computer designates any computing device having a processor, data and program storage capacity, and, where required, input/output devices for receiving end-user, promoter, and administrator inputs, as well as, again where required, a display and/or sound device, capable of presenting the administrator interface 24, promoter interface 26, end-user interface 34, and media element 32.

Typically, however, the backend server 12 and media provider 18 will be personal computers, mini-computers, or mainframe computers. Further, the promoter computer 14 and administrator computer 16 will preferably be personal computers, such as desktop computers or portable personal computers, although any other computing device having sufficient capacity, such as displays and input/output devices, to display the administrator interface 24 and promoter interface 26 and to receive inputs from administrative users and promoter users. Thus, promoter computer 14 and administrator computer 16 could also be “dumb” computer terminals, personal digital assistants (PDA), wireless telephones, or the like.

The end-user computer 20 may be any computing device capable of presenting an end-user interface and media elements 32 from the media provider 18 and/or backend server 12, notably by a display and/or sound device, and of receiving end-user input. Thus, the end-user computer 20 may be a personal digital assistant, a wireless telephone, a portable personal computer, a desktop computer, a computer terminal, a kiosk computer for presenting video, audio, and/or images in a kiosk, a computer connected to an advertising display, such as a digital billboard, or the like. Further, the end-user computer 20 could also be a digital jukebox 20, such as that furnished by Ecast™ Incorporated of San Francisco Calif., USA, which has a display for displaying video, images, movies, text, and the end-user interface 34, as well as an audio device for playing back digital audio and musical works, such as songs and/or sounds in digital format, and audio messages selected by end-users in locations where digital jukeboxes 20 are situated. Accordingly, the media elements 32, whether promotional or not, may be a digital musical work and/or digital video, notably a song in digital format or a music video in digital format, a movie, a text, a web-page, an audio message, a still-image, or any combination of the above in a machine readable digital format readable by the end-user computer 20. Similarly, the media provider 18 could be, for example, any on-line music or video service, such as I-tunes™ or Ecast™, or advertisement service providing advertisements 52 having promotional media elements 32.

Media elements 32 are typically stored in a media data store (MDS) 36, for example a media database 36, operated by the media provider 18 and may be in any machine-readable digital format, compressed or uncompressed, that can be played back by the end-user computer 20. Thus, for the purposes of example, the media elements 32 could be digital musical works, images, audio or video in any compressed digital format, such as, for example, Moving Picture Experts Group (MPEG), MPEG-1, MPEG-2, MPEG-4, advanced audio coding (AAC), windows media audio (WMA), joint photographic experts group (JPEG), motion joint photographic experts group (MJPEG), or the like. For the purposes of this description, presenting a media element 32 or presentation of a media element refers to displaying and/or playing the media element 32 using the appropriate input and output devices on the end-user computer 20. For example, presentation of digital musical or audio work 32, such as a song 32 or audio message 32, means that the song 32 or audio message 32 is played using a sound input/output device, such as a sound card or digital signal processor for audio connected to speakers on the end-user computer 20. Similarly, presentation of an image 32, video 32, text 32, movie 32, or web page 32 as media element 32 indicates that the video 32, web page 32, image 32, text 32, movie 32 is displayed on a display of the end-user computer 20. Where the media element 32 has both visual digital and audio components, for example, movies 32, videos 32, music videos 32, and web pages 32 having embedded sound or the like, the audio portion will be played along with display of the video portion. While the MDS 36 is typically resident on the media provider 18, the MDS 18 could also be situated on the EUC 20 and updated from the media provider 18 on an occasional basis. For example, in the event that the EUC 20 only has a dial-up connection to the MP 18, as opposed to a dedicated broadband connection, the MDS 36 on the EUC 20 could be updated with new elements from the MP 18 whenever the dial-up connection thereto is established or otherwise available.

To better aid the reader in understanding how the system 10 organizes advertisements 52 and campaigns 48 with reference to media elements 32 and how the system 10 locates appropriate media elements 32, advertisements 52, and campaigns 48 for end-user computers 20, reference is again made to FIGS. 2 and 3. More specifically, in FIG. 3, associations between different data entities preferably represented as database tables of database records, for example promoter accounts (PAID) 44 which represent promoters, are shown by solid lines which represent correspondences between data, typically database fields in the tables, by which the different data entities represented by them may be identified. In general, every promoter will have at least one promoter account (ACCOUNT) 44 having a, preferably unique, promoter account identifier (AID) 46 and account balance 47. Each promoter account 44 will also have promoter information (PRINFO) 43 describing the promoter, for example the promoter's name and address.

Referring still to FIG. 3, each promoter may, for each promoter account 44, have at least one campaign 48, identified primarily by a, preferably unique, campaign identifier (CID) 50 and associated with the promoter account 44 primarily by the account identifier 46. For each campaign 48, there may be at least one respective advertisement 52 associated therewith, primarily by the campaign identifier 50, and to the promoter account 44 by the account identifier 46 stored for the campaign 48. Each advertisement has a, preferably unique, advertisement identifier (ADID) 54.

For professional type promoter accounts 44, which may have multiple users, login names and passwords, there may be multiple campaigns 48, each campaign 48 having own respective CID 50 associated therewith. Each campaign 48 may have multiple advertisements 52 associated therewith. For a basic type account 44, there may be only one campaign 48 associated therewith, with each campaign 48 having only one advertisement 52 associated therewith. Accordingly, for basic type accounts 44, an advertisement 52 could, if desired, not be associated with a campaign 48 by the campaign identifier 50, but rather directly with the promoter account 44 by reference to the account identifier 46.

Each advertisement 52 is associated with a promotional media element record (MEDIAR) 57 by a promotional media identifier (PMID) 56, which is used to identify a respective media element 32 as the respective PME 32 for the advertisement 52. In general, it is the respective PME 32 that is presented to a user on the EUC 20 when the advertisement 52 is presented thereupon by the end-user interface 34. Thus, the advertisement 52 is represented by the respective PME 32 associated therewith. The PMID 56 is also used, more generally, as the primary identifier used within the backend server datastore (BSD) 40 to identify a given media element 32 within the BSD 40. The promotional media element record 57 for a media element 32 may contain one or more media information fields (MEINFO) 59 containing information relating to the media element 32, for example, artist, studio, label, licensing information, album name, year of release, or the like. A media type field (MTYPE) 61 indicates the type of media element 32, such as movie or video, web page, audio message, musical work, music video, web page, text, or the like.

Each media provider 18 is represented in the system by a media provider record (MPR) 63 which contains a, preferably unique, media provider identifier (MPID) 58 for identifying the media provider 18 and one or more media provider information fields (MPINFO) 71 containing information about the media provider 18, for example name, address, or the like. In turn, each media provider media identifier (MPMID) 60, used by the media provider 18, for example in the MDS 36, to identify a media element 32 offered thereby, is stored in a media provider media element record (MPMEDIA) 67. The MPMEDIA record 67 also contains the media provider media identifier 60 for the media provider 18 and the corresponding promotional media identifier 56 for the ME 32. Thus, by using the promotional media identifier 56, the media element 32 can easily be referenced on the media provider 18 by referencing the corresponding MPMID 60 and MPID 58 associated therewith.

Similarly, promotional media descriptors (PMDES) 66 for an advertisement 52 or campaign 48, represent a description of content, for example an artistic genre therefor, e.g. jazz, classical, science-fiction, of the promotional media element 32 associated therewith. Each PMDES 66 references a media descriptor record (MDES) record 160, with each PMDES 66 in the MDES 160 being associated with an equivalent record, via the MPID 58 and PMDES 66, in a media provider media descriptor record (MPMDESR) 162. The media provider media descriptor record 162 contains the equivalent media provider media descriptor (MPMDES) 164 for the PMDES 66 and a description (MPMDESINFO) 165 describing the MPMDES 164, for example an alphanumeric description specifying an artistic genre associated therewith. Thus, MPMDES 164 equivalents for promotional media descriptors 66 for any promotional media identifier 56, advertisement 52, or campaign 48 can be referenced easily.

Each end-user computer 20, for example a digital jukebox 20, has an end-user computer record (EUCR) 168, which contains a, preferably unique, end-user computer identifier (EUCID) 68 for identifying the end-user computer 20. The EUCR 168 also contains the MPID 58 of the media provider 18 operating the end-user computer 20 and a media provider end-user computer identifier (MPEUCID) 179 used by the media provider 18 to identify the end-user computer 20. In this fashion, the system 10, and notably the business module 38 and end-user interface 34, can easily reference and communicate with any end-user computer 20. Each EUCR 168 may also contain one or more location information fields (EUCLOC) 170 relating to a geographical location in which the EUC 20 is located. EUCLOC fields 170 may contain, for example, the address, city, county, state, province, country, telephone number, telephone prefix, longitude, latitude, and area code of the location the end-user computer 20 is situated. The EUCR 168 may also have one or more EUC spectator period fields (EUCSPEC) 174 which identify, based on information provided by the media provider 18, an estimated amount of spectators for an associated period of time, such as a day, week, month, or portion thereof. The EULOC 170 and EUCID 68 fields may be matched, for example by the business module 38, against advertisement location fields (ADLOC 172) of campaigns 48 and advertisements 52 to identify end-user computers 20 suitable therefor. Similarly, the EUC spectator period fields 174 may be referenced against the parameters set out in the target audience (TARGAUD) 96 and audience bid (EUDBID) 116 for advertisements 52 and campaigns 46 to identify end-user computers 20 suitable therefor. A specific end-user advertisement record (EUCADS) 176 may also be created containing, for a given advertisement identifier 54, an EUCID 68 for an end-user computer 20 for which the corresponding advertisement 52 is targeted.

Each EUCR 168 may reference, via the end-user computer identifier 68, an end-user computer media descriptor record (EUMDESR) 166, which contains a end-user computer media descriptor (EUMDES) 298 for the content, for example artistic genre, of the media elements 32 predominantly played on the end-user computer 20. The EUMDES 298 for the EUCID 68 in the EUMDESR 166 may be assigned by an administrator, using the administrator interface 24, based on information provided by the media provider 18. Alternatively, the media elements 32 played on the end-user computer 20 could be monitored, for example by the end-user interface 34, thus allowing, via lookup of the MPMID 60, PMID 56, and/or PMDES 66 and MPMDES 164, identification of the most commonly occurring PMDES 66 for MEs 32 presented thereon. The value of the most commonly occurring PMDES 66 could then be assigned to the EUMDES 298 for the EUCID 68 for the end-user computer 20 in the EUMDESR 166. Inclusion of the EUMDES 298 for an EUCID 68 in the EUMDESR 166 allows searching and matching of advertisements 52 and campaigns 48 with appropriate end-user computers 20 by matching the PMDES 66 for the advertisement 52, campaign 48, or promotional media element 32 therefor, against and the EUMDES 298 associated with the EUCID 66. Thus, information designated by the PMDES 66, such as artistic genre or the like, can be matched between EUCs 20 and advertisements 52, campaigns 48, and promotional media elements 32 therefor.

Every time a media element 32, whether a promotional media element 32 or not, is presented on an end-user computer 20, the presentation, reported by either the end-user interface 34 or the business module 38, is recorded in a presented media record (PRESREC) 180, which contains the PMID 56 for the media element 32, the EUCID 68 of the end-user computer 20 upon which the presentation occurred, the ADID 54 of the advertisement 52, if applicable, for which the presentation occurred, and the presentation time (PRESTIME) 182 of the presentation of the ME 20, which may include both the date and time of the presentation, perhaps within a specified tracking advertisement time period (ADTIME) 270 for which previous presentations are tracked for a given advertisement 52. Thus, for any ME 32 provided by a media provider 18 and registered therefore with PMID 56, all occurrences of presentations can be identified. Further, if an end user pays for presentation of the media element 32 on the EUC 20, then the fact that the user has paid for the presentation is recorded in the user payment information field (PAYINFO) 400, which may also contain the amount of the payment by the user. Thus, the system 10 can also track, if desired, presentations of a media element 32 based on whether they were presentations paid for by the user or whether they were free presentations, as well as the amount paid for each presentation for paid presentations.

Similarly, each designation of an advertisement 52, and thereby the respective PME 32 therefor, as presentable for selection by an end-user for presentation of the PME 32 is recorded in a presentable media record (PABLEREC) 184. The PABLEREC also contains the EUCID 20, PMID 56, and ADID 54 in association with which the PME 32 was designated as presentable, as well as a PABLETIME 186 field, which indicates the time, possibly within the ADTIME 270 period, that the PME 32 and advertisement 52 associated therewith were identified as presentable. Thus, when identifying promotional media elements 32 as presentable in association with an advertisement 32 or campaign 48, all previous designations of the promotional media element 32 as presentable and actual presentations thereof, whether paid or not, can be identified.

Optionally, the backend server datastore 40 may also have a table of advertising slot (ADSLOT) records 500, which contain data defining time slots reserved by media providers for presentation of advertisements 52 and their respective media elements 32 on respective EUCs 20 for advertisements 52. Specifically, each ADSLOT record 500 has a, preferably unique, slot identifier (SLOTID) 502, such as an alphanumeric sequence, which identifies the slot. Additionally, each ADSLOT record 400 also contains the EUCID 68 for the EUC 20 on which the slot is available, as well as a SLOTTIME field 504 which indicates the exact time and date for which the slot is available and the duration of the slot. The SLOTCOST field 506 indicates the cost of the corresponding slot, i.e. the compensation to be collected from the promoter by debiting the balance 47 of the account 44 thereof when the media element 32 for the advertisement is presented. The SLOTTIME 504, SLOTCOST 506 and EUCID 68 will typically be provided by the media provider and entered into the datastore 40, either automatically of manually by a system administrator, thus defining the available advertisement slots 500 and their respective times and costs. Each ADSLOT record 500 contains an ADID field 54 which may be populated with an ADID 54 of an advertisement 52, provided the remaining fields 502, 504, 506 have been populated, to reserve the slot for presentation of the advertisement 52 during the definition thereof, in which case ADDUR 92, SLOTTIME 504, EUCID 68, ADLOC 172, EUCLOC 170, and ADID 54 serve as the advertisement parameters defining the advertisement and governing identification of the presentable advertisement 52 by the business module 38. Any advertisement slot for which the ADID field 54 in the corresponding ADSLOT record 500 is not populated with a valid ADID 54 is an available slot and may be reserved by a promoter. Conversely, once the ADID field 54 for an ADSLOT record 500 is populated with a valid ADID 54, the corresponding ad slot is reserved for that advertisement 52, and therefore unavailable. The data in the ADSLOTS records 500 is always provided to the business module 38, either on a dedicated basis when there is a dedicated network connection between the EIC 20 and the back end server 12, or as part of a downloaded package of data provided with the business module 38 when only an intermittent or dial up connection between the EUC 20 and the backend server 20 is available.

Referring still to FIGS. 2 and 3, the system 10 has a variety of modules 130, 132, 134, 136 which update and modify the backend server datastore 40 and which provide inputs and outputs of data to and from the administrator interface 24, promoter interface 26, and end-user interface 34. Entries and modifications to the backend server datastore 40 from the promoter interface 26 or the administrator interface 24 to the backend server datastore 40 for campaigns 48 and advertisements 52 are primarily handled by an advertisement module 132 communicably coupled to the backend server datastore 40 and the promoter interface 26. When a campaign 48 or advertisement 52 is defined by a promoter using the promoter interface 26, it is the advertisement module 132 which creates and updates the campaign 48 and/or advertisement 52 in the backend server datastore 40. Preferably, each campaign 48 and advertisement 52 will be approved, after definition thereof by the promoter with the promoter interface 26, by an administrator using the administrator interface 24. Thus, preferably, the advertisement module 132 will not create or modify the advertisement 52 or campaign 48 in the backend server datastore 40 until an administrator has approved it. The advertisement module 132 may include any set of instructions, including a computer program or script, appropriate for carrying out the duties associated therewith.

The account module 130 is communicably coupled to the promoter interface 26, the administrator interface 24 and the backend server datastore 40. The account module 130 receives all account information and modifications thereto entered into the promoter interface 26 or the administrator interface 24, verifies the information so received, and stores it in the backend server datastore 40. The account module 130 is also responsible for debiting and crediting accounts 44, i.e. the account balance 47, so as to collect compensation in accordance with the SLOTCOST 506, advertisement budget (ADBUDGET) 106 and/or campaign budget (CBUDGET) 78, including bids 108, 116 specified therefor, for example when an advertisement 52, and more specifically the respective PME 32 associated therewith, is presented. The accounting module 130 may include any set of instructions, including a computer program or script, appropriate for carrying out the duties associated therewith.

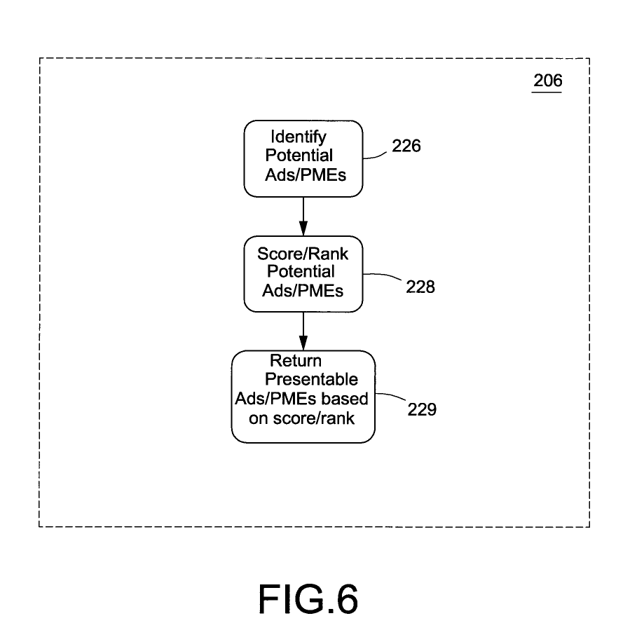

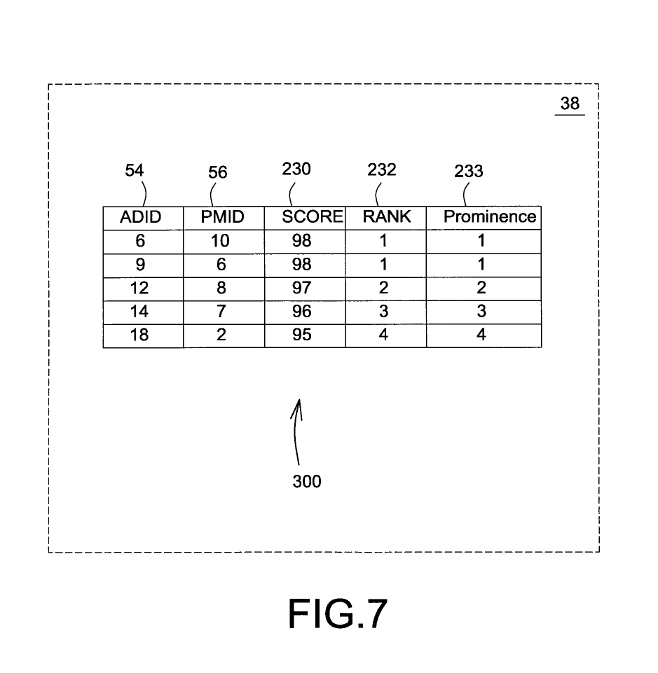

Reference is now made to FIGS. 3, 4 6, and 7. As best shown with reference to FIGS. 4 and 6, the business module 38 is responsible for identifying, at step 226, all potentially presentable advertisements 52 and campaigns 48 that may be potentially presentable for a given end-user computer 20 at any given time, notably in response to a predefined event 204 detected by the end-user interface 34. From the potentially presentable advertisements 52 and campaigns 48, the business module 38 identifies, at step 228, the presentable advertisements 52 and campaigns 48, and therefore the presentable promotional media elements 32 associated therewith. The business module 38 then, at step 229, returns, e.g. transmits, the presentable advertisements 52, specifically the identifiers 54 therefor, or the identifiers 56, 60 for the presentable promotional media elements 32 for the presentable advertisements 52 to the end-user interface 34. For example, the business module could generate an advertisement media set, shown generally as 300 in FIG. 7, which may consist of 0 or more presentable advertisements identifiers 54 and/or promotional media identifiers 56 to the end-user interface 34. The media set 300 could be in the form of, for example, a list or table data structure, and may also contain additional data elements, for example score 230, rank 232, and prominence 233 generated by the business module 38. Once the presentable promotional media elements 32 and/or presentable advertisements 32 have been identified, the end-user interface 34 processes presentation thereof. The business module 38 may be any set of instructions, including a computer program or script, appropriate for carrying out the duties associated therewith.

Referring to FIGS. 3, 4, and 5, the statistics module 134 stores all statistics for the system 10, for example using presentation records (PRESREC) 180 and presentable records (PABLEREC) 184, in the backend server datastore 40. Such statistics may include presentation data for advertisements 52 and campaigns 48, promotional media elements 32 associated with advertisements 52 and campaigns 48, and other media elements 32 on each end-user computer 20. The statistics module 134 also provides data to the administrator interface 24 and promoter interface 26 for generation and display of statistics and reports, for example at steps 216 and 217, that may show advertisement 52 and campaign 48 presentations for all or any given locations (EUCLOC) 170 of end-user computers 20, costs, and estimates/projections for presentations of advertisements 52 and campaigns 48 based upon parameters defined by promoters. The statistics module 134 may be any set of instructions, including a computer program or script, appropriate for carrying out the duties associated therewith.

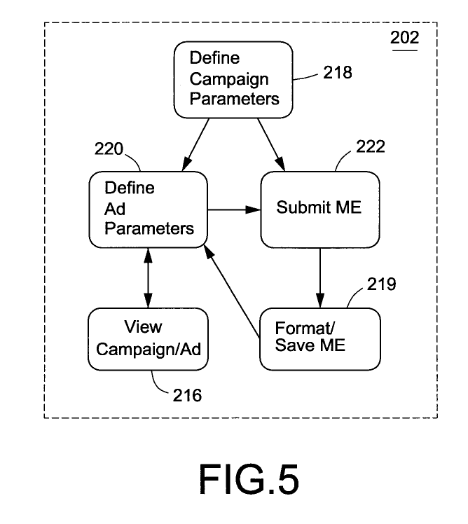

Referring now to FIGS. 3 and 5, the media submission module 136 is communicably coupled to the administrator interface 24, promoter interface 26, the backend server datastore 40, and the media provider 18, and is used by a promoter or an administrator to submit a media element 32 to the media provider 18. Generally speaking, before a media element 32 may be associated, as a promotional media element 32, with an advertisement, it must first be available to the media provider 18, generally in the respective MDS 36 thereof, for any end-user computer 20 for which the promoter may wish the advertisement 52 and promotional media element 32 to be presented. Accordingly, each media submission module 136 is configured for a specific media provider 18 and allows submission of an ME 32, at steps 219 and 222, thereto from the administrator interface 24 or promoter interface 26. The media submission module 136 may be any set of instructions, including a computer program or script, appropriate for carrying out the duties associated therewith.

Referring still to FIGS. 3 and 5, in terms of specific functionality provided by the promoter interface 26, the promoter interface 26 allows promoters to create their accounts 44 using a registration screen, not shown, provided thereby. Promoters may also modify their accounts 44, as well as campaigns 48 and advertisements 52 and view their account 44, including balance 47, advertisements 52, and campaigns 48 therefor, as well as to submit media elements 32 using the media submission module 136. Statistics, estimates, and projections, provided by the statistics module 134, for each campaign 48 and promotion 52 are also viewable from the promoter interface 26. Such statistics and estimates, which indicate the impact of advertisements 52 and campaigns 48, may show, for example, a number of presentations of advertisements 52 and promotional media elements 32 associated therewith, the costs of the advertisements 52, locations of the end-user computers 20 where the campaigns 48, advertisements 52, and promotional media element 32 associated therewith are presented, approximate numbers of spectators for the campaigns 48, advertisements 52, and promotional media element 32 associated therewith, or the like. These statistics and projections may be presented, at steps 216 and 217, in the form of reports in the form of, for example, graphics and spreadsheets, for campaigns 48 and advertisements 52. The reports may be customized on a variety of factors chosen by the promoter, for example, for specific advertisements 52 or campaigns 48, location of end-user computers 20 for presentation, cost, or the like. The promoter interface 26 also provides options for customizing appearance of the promoter interface 26 and for monitoring logins to promoter accounts 44 and for modifying access rights thereto.

The administrator interface 24 allows an administrator to carry out any of the tasks that a promoter may effect from the promoter interface 26. Further, the administrator interface provides an account management section that allows an administrator to view any information about promoter accounts 44, advertisements 52, and campaigns 48. The administrator interface 24 also allows the administrator to enter and modify the ADSLOTS records 500, when present, to define the slots provided by the media providers for each EUC 20. A media submission section of the administrator interface 24 lists all media elements 32 submitted using the media submission module 136, along with status information for submitted media elements 32, e.g. whether the media elements 32 have been accepted by the media provider 18 or not and/or whether the media element 32 may be used for an advertisement 52 and campaign 48. The media submission section of the administrator interface 24 also provides a list of actions available for the administrator, such as change of status for a submitted media element 32, resubmission of the media element 32 to the media provider 18, or to contact the promoter having submitted the media element 32. A reporting section of the administrator interface 24 generates reports for the administrator, for example at steps 216 and 217, including advertisements 52 presented, financial reports, and performance of the system 10. The promoter interface 24 and promoter interfaces 26 are, preferably, presented in the form of a web page. However, the interfaces 24, 26 may be presented in any format, and consist of any type of computer instructions and data, permitting the functionalities set out above.

To better aid the reader in understanding how campaigns 48 and advertisements 52 are created and subsequently processed by the system 10 for presentation on an end-user computer 20, FIG. 4 is now described in more detail. FIG. 4 shows a promotional digital media distribution method, shown generally as 200, for distributing promotional media, preferably using the system 10. Prior to distribution, i.e. presentation, of a promotional media element 32, the promotional media element must be associated with an advertisement 52, which itself may be associated with a campaign. Accordingly, at step 202, the advertisement 52 is created, either as a stand-alone advertisement 52 or as part of a campaign 48.

Next, at step 204, the end-user interface 34 monitors the end-user computer 20 for an occurrence of a predefined event 204 which may trigger presentation of one or more advertisements 52, and more specifically the promotional media elements 32 associated therewith. Proceeding to step 206, the business module 38 identifies, based on advertisement parameters defined at step 202, all advertisements 52, and more specifically promotional media elements 32 associated therewith, that may be presentable on the end-user computer 20 and transmits identifiers therefor, for example identifiers 54, 56, and 60, perhaps in the form of a media set 300, to the end-user interface 34. At step 208, the end-user interface 34 verifies whether there are any presentable advertisements 52, and more specifically presentable promotional media elements 32 associated therewith, identified by the business module 38. If not, proceeding to step 210, the end-user interface 34 simply transmits statistics indicating that no advertisement 52, and more specifically no promotional media element 52, was identified as presentable to the statistics module 134. Otherwise, proceeding to step 240, the end-user interface 34 determines whether a selection of a presentable promotional media element 32 is required. If not, the compensation for the advertisement 48 or campaign 52 is collected in accordance with the budget 78, 106, for example by debiting the account 44, at step 250 and the EUI 34 presents the presentable PME 32 on the end-user computer at step 246. The statistics are then updated at step 210 to record, among other things, presentation of the selected presentable promotional media element 32, as well as to record proposal of all the presentable promotional media elements 32 for selection.

If a selection is required, then the selection screen 236 is displayed at step 242 allowing selection of a reference 238 to the presentable promotional media element at step 244. If it is determined by the end-user interface, at step 248, that a presentable promotional media element 32 has been selected, then the end-user interface 34 proceeds again to step 250. Otherwise, the statistics are updated again at step 210 to show that no presentable promotional media element 32 was selected and to record which presentable promotional media elements 32 were proposed for selection. Reports, described previously, on the presentations and selections of presentable promotional media elements 32, advertisement 52, and campaigns 38 may be generated and viewed at any time, for example at step 217.

To better understand the process for defining campaigns 48 and advertisements 52 at step 202, reference is now made to FIG. 5 in conjunction with FIG. 3. As explained previously, for professional accounts 44, and if desired, a promoter may first, at step 218, define a campaign 48 associated with the account 44, the campaign 48 having a respective campaign identifier 50 associated with the account identifier 46 of the promoter. The promoter may then, at step 220, define one or more individual advertisements 52 associated with the campaign 48, each advertisement having an advertisement identifier 54. The account identifiers 46, advertisement identifiers 54 and campaign identifiers 50 are, preferably, automatically generated by the backend server datastore 40, possibly in conjunction with the advertisement module 132.

For each campaign 48, the advertiser may also define, at step 220, at least one common campaign advertisement parameter, such as a promotional media descriptor 66, campaign budget 78, an advertisement duration 92, an advertisement audience target 96, advertisement locations 172, and advertisement availability (ADAVAIL) 100, which will be applied commonly to all advertisements 52 defined for the campaign 48. More specifically, for each advertisement parameter 66, 92, 96, 100, 172, described in greater detail below, the values defined therefore by the promoter will be stored in association with the advertisement 52, as shown in FIG. 4. The campaign total budget 78, however, is a global amount of money defined by the promoter and which represents the total amount of money that the promoter is willing to spend, i.e. allocate, on all advertisements 52 for the campaign 48. Thus, every time a respective advertisement 52 for a campaign 48 is presented, a portion of campaign total budget 78 is consumed, i.e. collected as compensation, possibly by debiting the account balance 47. No more advertisements 52, and promotional media elements 32 associated therewith, will be identified as presentable by the business module 38 in association with the campaign 48 when the campaign total budget 78, as provided to the business module 38, either on a constant basis or during the last update thereof from the BSD 40 for implementations of the system 10 in which dedicated connections to the BSD 40 from the EUC 20 are unavailable, is exhausted. The other parameters 66, 92, 96, 100, 172 are defined, and subsequently processed during identification of presentable advertisements 206 and their respective promotional media elements 32,in the same manner as for individual advertisements 52 not associated with a campaign 48.

Once the campaign 48 is defined, or if the account 44 is a basic account or the promoter having a professional account 44 has chosen not to associate the advertisements 52 with a campaign 48, then, at step 220, the promoter may define an advertisement 52. For each advertisement 52, a respective promotional media element 32, chosen and/or submitted by the promoter is associated therewith, by association of the promotional media identifier 56 therefor with the advertisement identifier 54. In addition, the promoter may define one or more advertisement parameters 66, 92, 96, 100, 106, 108, 112, 114, 116, 172 therefor and which may be consulted by the business module 38 for determining which advertisements, and specifically which promotional media elements 32 associated therewith, are presentable.

Each advertisement 52 may have one or more advertisement location information fields (ADLOC) 172 which refer to locations in which the end-user computers 20 on which the advertisement 52 will be presented are situated, and may be specified as geographical addresses, states/provinces/counties, country, postal/zip code, telephone prefixes, telephone area codes, longitude, latitude, or by end-user computer identifiers 68. The business module 38 cross references the advertisement location information 172 against the end-user computer location information 170 when identifying which advertisements 52, and more specifically the promotional media elements 32 associated therewith, are presentable on an end-user computer 20.

The advertisement total budget (ADBUDGET) 106 designates the total amount of money which the promoter is willing to pay, i.e. allocate, for presentations of the advertisement 52, i.e. presentations of the promotional media element 32 associated therewith. Accordingly, once the amount of the advertisement total budget 106 has been reached, no further presentations of the advertisement 52, and more specifically the promotional media element 32 in association therewith, will be permitted. However, the same promotional media element 32 could still be presented in association with another advertisement 52. For advertisements 52 defined as part of a campaign 48, the advertisement total budget 106 is either replaced by, or further subject to, the campaign total budget 78.

The advertisement total budget 106, or the campaign total budget 106 for advertisements 52 defined as part of a campaign 48, is generally defined, for each advertisement 52, as at least one of a respective presentation bid (PRESBID) 108 and a respective audience (AUDBID) bid 116. The presentation bid 108 is the maximum amount that the promoter is willing to pay per presentation of the advertisement 52, and the promotional media element 32 associated therewith, on an end-user computer 20. The audience bid 116 corresponds to a maximum amount that a promoter is willing to pay for a fixed amount of spectators, i.e. audience, for one or more presentations of the advertisement 52, more specifically presentation of the promotional media element 32 associated therewith. For example, for the target audience bid 116, the promoter could bid $5 per 1000 spectators. In this case, the 1000 spectators could refer to, and be evaluated against, 1000 end-users which actually select the advertisement 52, and thereby the PME 32 associated therewith, for presentation, i.e. 1000 presentations. Alternatively, the target audience bid 116 could refer to, and be evaluated against, the respective EUC spectator period 174 for end-user computers 20 which contains estimated numbers of spectators for an end-user computer 20 for a predefined period of time. In such case, for a bid of $5 for 1000 spectators, $5 would be collected every time, regardless of the number of presentations, that the number of estimated spectators reached by all presentations of the promotional media element 32 in conjunction with the advertisement 52 in desired locations, for example on desired end-user computers 20 referenced by advertisement location information 172 against end-user computer location information 170, reaches 1000. Optionally, should a bid 108, 116 exceed the next closest bid 108, 116 by a predefined excess amount (PEXCESS) 250 definable on the administrator interface 24, for example twenty percent, the higher bid 108, 116 will be reduced to the sum of the predefined excess amount and the closest lower bid 108, 116. The predefined excess amount may also be applied, as configured by the administrator, to the total advertisement budget 106 and campaign budget 78.

The promotional media descriptor 66, when specified by the promoter, describes the content of the promotional media element 32, for example and as explained previously, by artistic genre, e.g. jazz, classical, or the like, for the PR 52. By cross-referencing the promotional media content descriptor 66 with the end-user computer media descriptor 298, the business module 38 can identify end-user computers 20 for which the parameters 66, 120 are a match and identify end-user computers 20 for which the description of the content, such as artistic genre, of the media elements 32 predominantly played thereupon are a match for the promotional media element content descriptor 66.

The advertisement target audience (TARGAUD) 96, when defined by the promoter for an advertisement 52, refers to the desired potential audience, i.e.

number of spectators, for the advertisement 52 per end-user computer 20, or per location in which an end-user computer 20 is located, over a fixed period of time, for example a day or a week. The advertisement audience 96, when specified, is verified by the business module 38 against the respective EUC spectator periods 174 for an end-user computer 20 to evaluate whether the desired advertisement audience 96 can be fulfilled, preferably without exceeding the desired advertisement audience, by presentation of the advertisement on the end-user computer 20.

The advertisement presentation maximum (APM) 112, when specified by the promoter, refers to a maximum number of presentations of the advertisement 52, i.e. presentation of the respective PME 32 in conjunction therewith, per location in a predefined advertisement period of time (ADTIME) 270, also an advertisement parameter definable by the promoter or administrator. For example, the APM 112 could indicate a maximum of 5 presentations per location, e.g. based on correspondence between location parameters 170, 172, per day.

The advertisement availability parameter (ADAVAIL) 100 allows the promoter to specify whether presentation of the advertisement 52 and PME 32 associated therewith will be conditional on occurrence of a predefined event, for example payment of a user fee for the end-user computer 20, e.g. a playing fee for playing a song 32 or music video 32 on a digital jukebox 20. The special offers (OFFERS) parameter 114 specifies an optional special offer associated with the advertisement 52, for example a free download of a media element 32, a gift certificate, or a free presentation of an ME 32 which may be made available as part of the presentation of the advertisement 52 and the promotional media element 32 associated therewith.

The advertisement duration (ADDUR) 92 specifies a period of time during which the advertisement 52 may be presented, for example by start date and end date. The advertisement duration 92 may also simply specify a start time, with the end of availability of the advertisement being determined based on any combination of exhaustion of the advertisement budget 106 or campaign budget 78, when specified, or attainment of the number of spectators specified for the target audience 96, when specified, for the desired advertisement locations 172, when specified, corresponding to, when specified, the promotional media descriptor 66. An advertisement prominence parameter (ADPROMINENCE) 280 may also be specified to indicate a promoter's preference, when an advertisement 52, and thereby the respective promotional media element 32 therefor, is identified as presentable, a relative prominence of the reference 238 therefor compared to other references 238, typically references 238 for promotional media elements 32 in association with advertisements 52 belonging to the same campaign 48, on the selection screen 238.

As an alternative method for defining the advertisements 52, notably where ADSLOTS records 500 are available in the BSD 40, a promoter may define, at step 220, the advertisement parameters 172, by selecting specific advertisement slots 500 on specific EUCs 20 in desired locations 170 for presentation thereof for specific costs, namely SLOTCOST 506, until the ADBUDGET 106 is exhausted. In such a case, based on desired locations for presentation of the advertisement 52, for example ADLOC 172, and a desired time period of presentation, such as ADDUR 92, entered by the promoter via the promoter interface 26, the promoter interface 26 will display available ADSLOTs 500 for EUCs 20 for which the EUCLOC 170 matches with ADLOC 172 and for which the SLOTTIME data 504 falls within the desired time period 92, as well as the respective cost, i.e. SLOTCOST 506 thereof. The promoter may then select specific advertisement slots by selecting specific ADSLOT records 400. If the predefined event 204 occurs during the SLOTTIME 504 for an advertisement slot for an EUC 20, or within a predefined lead time, for example 5 minutes, immediately prior thereto, then the business module 38 will identify the advertisement 52 having the ADID 54 specified in the ADSLOT record 500 as the only presentable advertisement 54 for the EUC 20 in response to the predefined event 204. Obviously, for this alternative, and simplified, approach 220, the ADSBUDGET 106, and the PMID 56 for the media element 32 will also have to be defined, along with a campaign budget 78 if the advertisement 52 is part of a campaign 48. However, most of the other parameters 92, 96, 100, 108, 116, 112, 66, 270, 280, 66 can be omitted. Preferably, but not necessarily, each implementation of the system 10 and method 200 will offer one method for defining the advertisements 52 and their parameters, namely either by assigning advertisements 52 and their respective media elements 32 to specific ADSLOTS records 500 or by defining all of the advertisement and campaign parameters in detail, as previously described.

Referring now FIG. 5 in conjunction with FIGS. 2 and 3, should a desired media element 32 for an advertisement 52 be unavailable on a media provider 18 for which the end-user computers 20 are among those corresponding to the advertisement parameters 66, 92, 96, 100, 106, 108, 112, 114, 116, and 172 then the promoter will be required, at step 222, to submit the media element 32 using the media submission module 136. As each media submission module 136 is customized for each media provider 18, the media submission module 136 provides for submission of a media element 32 to the media provider 18 in a specific, and possibly proprietary, format, shown generally as 190 required by the media provider 18, and notably the media datastore 36. This media provider format 190 may include a media provider media descriptor (MPMDES) 164, for example describing the artistic genre of the media element 32, the media element 32 converted into a specific digital format, and the media provider media identifier 60 therefor. Accordingly, the media submission module 136 allows a promoter or administrator to submit the media element 32 along with a promotional media descriptor 66 therefor, preferably selectable from the interfaces 24, 26, as well as a media provider identifier (MPID) 58 for the media provider 18. The media provider identifier 58 may be located by the media submission module 136 by looking up the media provider 18, based on matching advertisement location parameters 172 with end-user computer location parameters 170, an EUCID 68, the media provider identifier 58, or any other parameters for the advertisement 52 which may be matched against parameters identifying an end-user computer 20, and thereby the respective media provider 18 therefor. When the media element 32 is submitted from the interfaces 24, 26, the media submission module 136 then formats the media element 32, at step 219, to the media provider format 190 required by the media provider 18, including an equivalent media provider media descriptor 164 for the promotional media descriptor 66 therefor and transmits the media element 32 in the media provider format 190, including the media provider media descriptor 68 therefor, to the media provider 18 for approval. The media submission module 136 also creates a promotional media element identifier (PMID) 56 for the media element 32 in the backend server datastore 40, along with the promotional media descriptor 66, and other media element information 59 therefor.

If the media element 32 is accepted by the media provider 18, which generally results in a media provider media element identifier 60 being created therefore by the media provider 18, then the media submission module 136, either automatically or upon receiving instruction from an administrator using the administrator interface 24, enters the identifier 60 into the backend server datastore 40 and associates it with the promotional media identifier 56 in a music provider media record (MPMEDIA) 67 therefor at step 219. It is only after approval by the media provider 18 and entry of parameters 56, 60, 66, 59, and 58 for the ME 18 into the backend server datastore 40 that the media element 32 may be assigned to an advertisement 52 as a promotional media element 32. The same steps for submitting a media element 18 using the media submission module 136 may also be undertaken by an administrator using the administrator interface 24. Reports for an advertisement 52 and campaign 48, including projections therefor, may be generated at step 216 and allow a promoter to see estimated presentations, costs, or the like before the advertisement 52 or campaign is finalized, as well as during the advertisement duration 92.

Referring again to FIG. 4, once an advertisement 52 or campaign 48 has been defined and approved, it may be identified, i.e. designated, as presentable by the business module 38. More specifically, identification of an advertisement 52 and campaign as presentable signifies that the respective promotional media element 32 associated therewith is identified as presentable in association therewith, and that any compensation for presentation will be determined based on the budgets 78, 106 for that specific advertisement 52 and/or campaign 48. As mentioned previously, on each end-user computer 20, the end-user interface 34 constantly monitors the EUC 20, for an occurrence of a predefined event 204, which may be required depending on the availability parameter 100 for the advertisement 52, for triggering presentation of an advertisement 52. Such an event 204 could include, for example where the end-user computer 20 is a digital jukebox 20 and the promoted media element 32 is a music video 32 or a digital musical work 32, such as a song 32, payment of a user fee, such as purchase of credits for playing songs 32 or music videos 32 on the end-user computer 20 by using currency, banking cards, or other means. Alternatively, the event 204 could be passage of a predefined period of idle time, defined by the EUCIDLE parameter 272, in which the end-user computer 20 has been inactive. Advertisements 52 having an audio message 32 as the promotional media element 32 could require, for example, that the end-user computer 20 be in between presenting other media elements 32 or promotional media elements 32 or that the predefined period of idle time 272 have expired.

To better aid the reader in understanding identification or presentable advertisements 52 and media elements at step 206, reference is now made to FIGS. 6 and 7. When the end-user interface 34 determines, upon detection of the predefined event 204 if required, that an advertisement 52 should be presented, the business module 38 evaluates the advertisement parameters 66, 78, 92, 96, 100, 106, 108, 112, 114, 116, 172, 270, 280, 400, 404, 406 to determine which advertisements 52, and their associated promotional media elements 32, are presentable. The business module 38 also consults, using the end-user computer identifier 68 for the end-user computer 20, the presented media records 180 to determine, for the advertisement period 270, e.g. the current day, the number of previous presentations of the advertisement 52 and the last time of presentation of the advertisement 52 and the promotional media element 32 therefor, either for the advertisement 52 or not. The business module may also consult, again using the EUCID 68, the presentable media records 184 to determine the number of times the advertisement 52 and/or promotional media element 32 therefor has been identified as presentable and proposed to the end-user by the end-user interface 34 on the end-user computer 20 for the advertisement period 270 of time. The method by which the determination of presentable advertisements 52 and their respective promotional media elements 52 is effected is demonstrated by steps 226, 228, and 229.

Initially, at step 226, the business module 38 identifies all potentially presentable advertisements 52 which may be presentable, i.e. potentially targeted to, the end-user computer 20, and notably the end user computer identifier 68 therefor. The business module 38 could determine the potentially presentable advertisements 52 by verifying correspondence between, for example and where specified for the advertisement 52, the advertisement location 172 and the EUC location 170, the promotional media descriptor 66 and the end-user computer media descriptor 298, and the advertisement audience 96 and the EUC spectator periods 174. The business module 38 could also cross reference, if desired, the PRESREC 180 and PABLEREC 184 tables to determine which media elements 32 have been played or have been designated as presentable on the end-user computer 20 and their respective PMDES 66 and MEINFO 59 fields to determine which types, for example, artistic genre, of MEs 32 are most frequently presented on the end-user computer. Further, such a consultation of data elements 180, 184, and 66, along with the PAYINFO field 400, could further allow, if desired, selection of potentially presentable advertisements 52 based on payment, and the amount thereof, of certain types of MEs 32, as determined by the PMDES 66. For example, by consulting the PMDES 66 and MEINFO 59 fields, along with the PAYINFO field 400, potentially presentable advertisements 52 could be limited to advertisements 52 having a respective PME 32 of a specified artistic genre, artist, or type for which end-users have paid, or not, for presentation or which have been presented either a specified minimum number of times in a given period. In all cases, the business module 38 eliminates from consideration all advertisements 52 for which the advertisement duration 92 has expired and total campaign budget 78 or advertisement budget 106 has been exhausted. An advertisement is also excluded for consideration on a given EUC 20 if the EUCID 68 therefor is on a blocked list, accessible by the operator of the MP 18 from the MP itself or by the administrator interface 24, associated with the ADID 54, the campaign identifier 50, or the account identifier 46 for the promoter. The remaining advertisements 52 are identified as the potential advertisements 52 for presentation on the end-user computer 20, i.e. potentially presentable advertisements 52, with their respective promotional media elements being potentially presentable media elements 32.

Referring to FIGS. 2, 6, and 7, once the business module 38 has identified the potentially presentable advertisements 52, and thereby the respective potentially presentable promotional media elements 32 therefor, at step 226, the business module 38 ranks the potential advertisements at step 228 by calculating a respective score 230 for each potential advertisement 52, with advertisements 52 having higher scores having higher ranks 232. In general, the business module generates the score “SCORE” 230 by applying the following calculation algorithm to each potential presentable advertisement identified at step 226.

SCORE=BID*BW+(APM−TP)*(APMW)+(CT−LT)*TVV−TPABLE*TPABLEW

Referring to FIGS. 2, 6, and 7, in the formula for SCORE 230, BID is the bid 108, 116 for the promotion, i.e. either the presentation bid 108 or the audience bid 116. APM is the desired advertisement presentation maximum 112 for a given advertisement period of time (270), for example per day. TP is the number of times the media element 32 associated with the promotion has already been presented during the advertisement period 270 [whether as a promotional media element 32 for the advertisement 52 or not]. Thus, (APM−TP) represents the remaining number of presentations before the APM 112 is reached. CT is the current time within the advertisement period 270, for example the current time of the current day or date on the end-user computer 20. LT is the last time within the advertisement period 270 that the promotional media element 32 associated with the advertisement 52 was presented on the end-user computer 20 during advertisement period 270, whether, depending on the configuration of the system 10, as a promotional media element 32 for the advertisement 52 or not. Thus, the difference (CT−LT) represents a presentation time interval lapsed since the last presentation of the promotional media element 32 associated as a promotional media element 32 with the advertisement 52 [whether as a promotional media element 32 for the advertisement 52 or not]. TPABLE represents the number of times that the advertisement 52, and therefore the respective promotional media element 32 associated therewith, has been identified as presentable in the advertisement time period as a as a promotional media element 32 for the advertisement 52, or, if desired, for any other advertisement 52.

BW 262 is a bid weight factor, and which determines the relative importance of the bid in calculating the score versus the time interval of (CT−LT), the remaining number of presentations (APM−TP) before the advertisement presentation maximum 112 is reached, and the number of times the promotional media element 32 for the advertisement 52 has been identified as presentable and proposed to the user 32 in the advertisement time period 270. Similarly, APMW 268 is a weight factor for the remaining number of presentations (MP−TP) versus the time interval (CT−LT), BID 108, 116, and the TPABLE. In the same fashion, TW 264 and TPABLEW 266 are weight factors to determine the weight of the time interval (CT−LT) and TPABLE in calculating the score. MPW, BW, TW, TPABLEW remain constant during the calculation of the score for every potential advertisement 52 identified at step 226. In other words, the same value for BW 262 applies for the calculation of the score 230 for every potentially presentable advertisement 52 during an iteration of step 228, as do the respective values for TPABLEW 266, TW 264, and APMW 268. However, the values assigned to the weights 262, 264, 266, 268, stored in a weights record 260, may be changed, either automatically or by an administrator using the administrator interface 24, to change the relative weights thereof. Obviously, by assigning a value of zero to any weight 262, 264, 266, 268, the relative weight for, respectively, BID, (CT−LT), TPABLE and APM 112 in calculating the score 230 would be null.

Once the scores 230 and ranks 232 based thereupon are determined at step 228, the business module 38, at step 229, identifies, possibly as a media set 300, which advertisements 52 are presentable advertisements for the EUC 20 and transmits this information, possibly as a media set 300, to the end-user interface 34 on the end-user computer 20. The identification at step 229 of which advertisements 52, and their respective promotional media elements 32, are identifiable is based on the respective rank 232 of each advertisement 52 and a presentable advertisement quantity number representing the advertisements 52 which must be identified, if possible, as presentable. Accordingly, the business module 38 identifies a quantity of advertisements 52 corresponding to the presentable advertisement quantity, starting with the highest ranked advertisements 52 and then proceeding in descending order of rank 232. In other words, if the presentable advertisement quantity is five, then the five advertisements 52 having the highest rank 232, i.e. the highest respective scores 230, will be identified as the presentable advertisements 52. If the presentable advertisement quantity is insufficient to include all advertisements 52 having the same respective score 230 and rank 232, for example if six presentable advertisements 52 must be identified and there are seven advertisements 52 all having the highest score 230 and rank 232, then the business module 38 will identify a sufficient number of advertisements 52 having the same score 230 and rank 232 to reach the presentable advertisement quantity, based on a predefined tiebreaking criteria, for example the last time presented, the presentation bid 116, or the like. The presentable advertisement quantity could be, for example, an optional end-user computer presentation maximum (EUCSMAX) 292 could be specified for an end-user computer 20, in association with the EUCID 68, to indicate the maximum number of promotional media elements 32 that may be proposed thereupon at any given moment. Thus, the business module 38 would limit the number of presentable promotional media elements 32 or advertisements 52 identified in the media set 300 to no more than the maximum indicated for the EUCSMAX 292 for the end-user computer 290.

The presentable advertisement quantity depends on the configuration of the end-user interface 34, and notably the number of advertisements that either the media provider 18 or an administrator wishes to have proposed to the end-user at any given moment. For example, an optional end-user computer presentation maximum (EUCSMAX) 292 could be specified for an end-user computer 20, in association with the EUCID 68, to indicate the maximum number of promotional media elements 32 that may be proposed thereupon at any given moment, in which case the presentable advertisement quantity number would be the value of EUCSMAX 292.

Alternatively, where the advertisements 52 are defined by assignment of the ADID 54 to ADSLOT records 500, the business module 38 could simply verify at step 206 whether the predefined event 204 has occurred within, or during a predefined lead time immediately preceding, the SLOTTIME 502 for an ADSLOT record 500 for the EUC 20. If so, and an ADID 54 has been entered for the ADSLOT record 500, then the advertisement 52 for that ADID 54 is automatically designated as the only potentially presentable advertisement 52 and the method proceeds to step 208. Otherwise no potentially presentable advertisement 52 is identified and the method proceeds to step 208.

It should also be noted that, when the business module 38 is resident on the end-user computer 20, i.e. for dial-up implementations of the system 10 where a constant broadband connection is unavailable between the backend server 12 and the end-user computer 20, the business module 38 on the end-user computer 20 also conducts step 226 when a network connection between the end-user computer 20 and the backend server 12 becomes available. After the potential advertisements for the end-user computer 20 have been identified, the business module 38 on the end-user computer 20 downloads the advertisements 52 for subsequent processing should the predefined event 204 occur. Typically, the business module 38 will also download the number of previous presentations of the advertisement 52, and/or promotional media element 32, the time of the last presentation thereof on the end-user computer 20, the PAYINFO 400 data, and the number of times the advertisement 52 and/or promotional media element 32 therefor has been identified as presentable and proposed to the end-user by the end-user interface 34 on the end-user computer 20 in the predefined advertisement period 270. Statistics for the advertisements 52 presented or identified as presentable, as well as presentations of all media elements 32, whether promotional media elements 32 or not, and advertisements 52 proposed to the end-user are sent to the backend server 12 when the next connection to the backend server 12 becomes available. Any changes to the business module 38 are also downloaded to the EUC 20 when the connection comes available. Similarly, any MEs 32 for the MP 18 for an EUC 20 are downloaded to the EUC 20, for configurations where a continuous connection between the media provider 18 and the EUC 20 is unavailable, when a connection therebetween becomes available. In such configurations, the MDS 36, and MPID 58 could be stored on the EUC 20. Such configurations between the EUC 20 and the back-end server 12 or media provider 18 could include, for example, dial-up configurations where the EUC 20 occasionally connects, perhaps at predefined times or intervals, using a dial-up connection to the backend server 12 or the media provider 18.

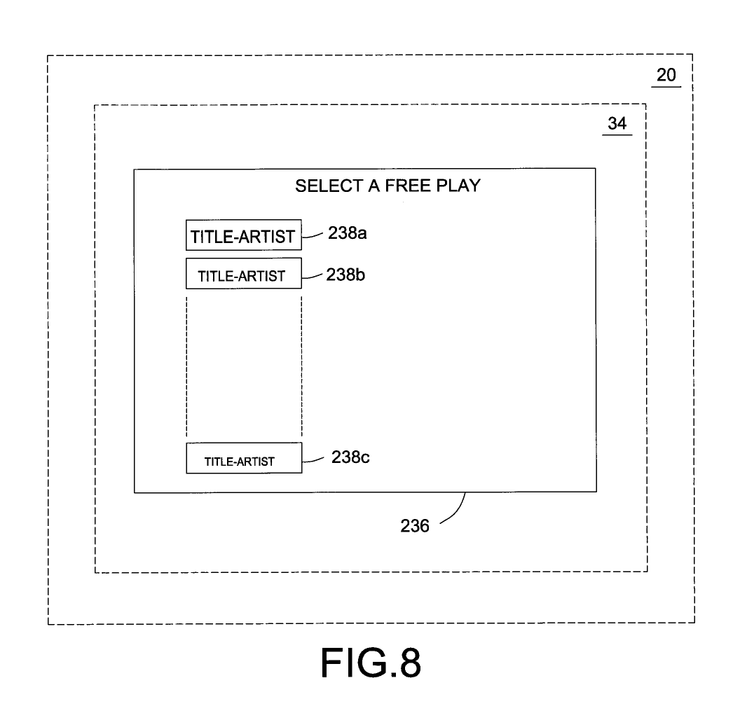

Returning again to FIG. 4, once the presentable advertisements 52 have been identified, the business module 38 will determine, at step 240, if a selection of an advertisement 52, and more specifically the promotional media element 32 associated therewith, among the presentable advertisements 52 is required, at step 224. A selection by the user will be generally required when the number of presentable advertisements 52 identified at step 206 is greater than one. However, a selection may nonetheless, based on the type of media element 32 for the advertisement 32 and the configuration of the system 10, be required even when there is only one presentable advertisement 52, in which case the user simply selects whether to have the promotional media element 32 for the presentable advertisement 52 presented or not. For example, for end-user computers 20 that are jukeboxes 20 and for which the promotional media elements 32 associated with the advertisements 52 are songs or music videos, a selection will typically be required. In such cases, proceeding to step 242, the end-user interface 34 will display a selection screen 236, shown in FIG. 8, displaying a selectable reference 238 to each promotional media element 32 associated with the presentable advertisements 52.

The reference 238 could be, for example, a title of the musical work, artist name, album name, album cover image, artist image, or the like, included as part of a link, for example a hypertext link, which, when selected at step 244, causes the musical work 32 or music video 32 to be presented at step 246, for example, played by downloading thereof from the media provider 18 to the end-user computer 20 and queued for subsequent presentation thereon. The reference 238 could also link to a web page, as the promotional media element 32, providing a gift certificate, a free presentation of a media element 32 to be selected by the user, or a free download of a media element 32. Additionally, the reference 238 could also link to an interface, not shown, requesting input by the user of contact information, such as an electronic mail address, for contacting the user for continuing the promotion by directly contacting the user, for example by sending a PME 32 to the e-mail address. As another option, the reference 238 could, in cases where the MEINFO 59 field contains an album name for an album upon which the PME 32 for the advertisement 52 is present, reference a list of all MEs 32 on the album that are available on the EUC 20. The user could then select the album name, view the list, and select a media element 32, including a media element other than the PME 32 associated with the advertisement 52, for presentation. For implementations of the system 10 and method 200 in which a dedicated/constant network link to the MP 20 for the EUC 18 is unavailable the reference 238 would reference the ME 32 on the EUC 20 for queuing or play thereof.

The references 238 may be organized on the selection screen 236 in a variety of fashions, such as a list of references 238 in text form, a series of references 238 presented in image form, or the like. Further, and referring now to FIGS. 7 and 8, each selectable reference 238 may be proposed, e.g. displayed, at step 240, with a greater or lesser degree of prominence, based on a respective prominence ranking 233 determined by the rank 232 and score 230, compared to other references 238 to increase a probability that the selectable reference 238, and therefore the promotional media element 32 associated therewith, will be selected. References 238 for presentable promotional media elements 32 for advertisements 52 having higher rank 232 and scores 230 have a correspondingly higher prominence ranking 233 and would be more prominently displayed on the selection screen 236 then references 236 for promotional media elements 32 for advertisements 52 of lower rank 230 and prominence ranking 233. For example, references 238a with higher prominence rank 233, for example a prominence rank of 1, could be displayed with larger text or higher up on the screen 236, than references 238b, 238c for lower ranked presentable promotional media elements 32 having a lower prominence ranking 233, for example a prominence ranking of 2 and 3. If there is only one presentable advertisement 52, then the reference 238 is simply presented with an arbitrary degree of prominence, without reference to the rank 232 and score 230.

As previously mentioned, in certain circumstances, for example when there is only one presentable advertisement 32 and which has an audio message 32 or single image 32 as the promotional media element 32, the presented media element 32 could simply, proceeding directly from step 240 to 246, be presented without selection or other user input. In such cases, no selection screen 236 is presented. Instead, the compensation is automatically collected at step 250, by updating of the account 44, notably the balance 47 thereof, in accordance with the advertising budget 106. Thus, a compensation in accordance with the budget 78, 106, and specifically bids 108, 116 or the SLOTCOST 406, is attributed against the account 44, and thereby collected from the promoter. The media element 32 associated with the advertisement 52 is then instantaneously presented at step 246. After presentation of the media element at step 246, the statistics for the promotional media element 32 are transmitted at step 210. If it is determined by the end-user interface, at step 248, that a presentable promotional media element 32 has been selected, then the end-user interface 34 proceeds again to step 250.

It should be noted that, except for advertisements 52 defined for specific ADSLOT records 500, the amount debited for the account 44 at step 250 may be varied, for example scaled, based on the EUC spectator period 174 data for the end-user computer 20 on which the promotional media element 32 is presented. Specifically, if the presentation occurs during an EUC spectator period 174 having the highest amount of spectators associated therewith, for example a jukebox 20 in a bar on a Saturday night, then the amount debited from the account 44, i.e. the compensation for the presentation, could be 100% of the bid 108, 116. If the presentation occurs during an EUC spectator period 174 associated with lower numbers of spectators for the end-user computer 20, such as Monday morning in bar, only a partial amount, associated with the lower EUC spectator period 174, could be debited from the bid, for example 20 percent of the bid 108, 116.

Although the present system and method has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1. A system (10) for presenting digital media for promotion thereof to an end-user, the system (10) comprising:
a respective promoter interface (26) for defining at least one advertisement (52) having at least one respective advertisement parameter (66, 78, 92, 96, 100, 106, 108, 112, 114, 116, 172, 270, 280, 504, 506) and designating, from at least one media element (32) of the digital media, a respective promotional media element (32) associated with said advertisement (52);
at least one end-user interface (34) communicably coupled to a respective end-user computer (20) accessible by the end-user for detecting at least one predefined event (204) and presenting, in response thereto, said respective promotional media element (32) of at least one presentable advertisement (52) of said at least one advertisement (52); and
a business module (38) communicably coupled to said promoter interface (26) and to said at least one end user interface (34) for identifying, upon detection of said predefined event (204) and based upon said at least one respective advertisement parameter (66, 78, 92, 96, 100, 106, 108, 112, 114, 116, 172, 270, 280), said at least one presentable advertisement (52).

2. The system (10) of claim 1, wherein said advertisement parameter (66, 78, 92, 96, 100, 106, 108, 112, 114, 116, 172, 270, 280) comprises at least one of an advertisement location (172) defining for said advertisement (52) a desired geographical location of said end-user computer (20) for presentation of said respective promotional media element (32) for said advertisement (52), a respective promotional media element descriptor (66) describing a respective content of said respective promotional media element (32), a respective advertisement duration period (92) during which presentation of said respective promotional media element (32) for said advertisement (52) is desired, a respective advertisement budget (106), a respective advertisement target audience (96) indicating a desired number of spectators for said respective promotional media element (32) for said advertisement (52) over said respective advertisement duration period (92), and a respective advertisement presentation maximum (112) representing a maximum number of presentations desired in said advertisement location (172) for said respective promotional media element (32) for said advertisement (52) during a respective advertisement period (270) of time within said respective advertisement duration period (92).

3. The system (10) of claim 2, wherein said business module (38) identifies said at least one said presentable advertisement (52) by generating a respective score (230) for each advertisement(52) based on at least one said respective advertisement parameter (78, 92, 96, 106, 108, 112, 114, 116, 172, 270).

4. The system (10) of claim 3, wherein said at least one said respective advertisement parameter (78, 92, 96, 106, 108, 112, 114, 116, 172, 270) comprises at least one of said respective advertisement budget (106), said respective advertisement duration (92), and said respective advertisement presentation maximum (112).

5. The system (10) of claim 4, wherein said business module (38) collects a respective compensation for said advertisement (52) in accordance with said respective advertisement budget (106).

6. The system (10) of claim 4, wherein said respective advertisement budget (106) comprises at least one of a respective presentation bid (108) collectable each time said respective promotional media element (32) is presented for said advertisement (52) and a respective audience bid (116) collectable upon presentation of said respective promotional media element (32) for said advertisement (52) to a predefined number of spectators associated with said end-user computer (20) during a respective end-user computer spectator period (174) associated therewith and during which said predefined event occurs, said respective end-user computer spectator period (174) defining an associated period of time and an estimated quantity of spectators therefor.

7. The system (10) of claim 6, wherein, during calculation of said respective score, said business module weights said respective presentation bid (108) and said respective audience bid (116) by an adjustable bid weight (262) and said respective advertisement presentation maximum (112) by an adjustable advertisement presentation maximum weight (268).

8. The system (10) of claim 4, wherein said respective score (230) is further based upon at least one of a respective total number of previous presentations for said respective promotional media element (32) for said advertisement (52) in said respective advertisement period (270) of time compared to said advertisement presentation maximum (112) therefor, a respective total number of previous identifications of said advertisement (52) as presentable in said respective advertisement period (270) of time, and a time interval between said predefined event (204) and a last time of presentation of said respective promotional media element (32) within said respective advertisement period (270) of time.

9. The system (10) of claim 7, further comprising an administrator interface (24) communicably coupled to said business module (38) and from which said bid weight (262) and said advertisement presentation maximum weight (268) are definable by an administrator of the system (10).

10. The system (10) of claim 6, wherein said business module (38) decreases said compensation when said respective end-user computer spectator period (174) during which said respective promotional media element (32) for said advertisement (52) is presented has respective a lower said estimated quantity of spectators and increases, up to said respective presentation bid (108), said compensation when said respective end-user computer spectator period (174) during which said respective promotional media element (32) for said advertisement (52) is presented has a respective greater said estimated quantity of spectators.

11. The system (10) of claim 2, further comprising a media submission module for submitting, for said advertisement (52), said respective promotional media element (32) therefor to a media datastore (36) communicably coupled to said end-user computer (20) and in which said at least one media element (32), including said respective promotional media element (32) is stored.

12. The system (10) of claim 1, wherein said predefined event (204) is at least one of a payment of a user fee for use of said end-user computer (20) and expiration of a predefined idle period (272) of idle time in which said end-user computer (20) is idle.

13. The system (10) of claim 1, wherein each media element (32) is in digital format and comprises at least one of a musical work (32), a video (32), a web page (32), a text (32), an audio message (32), and an image (32), said media element being in digital format.

14. The system (10) of claim 2, wherein said media element (32) comprises one of a musical work (32), a video (32), and an audio message (32), in digital format, and said end-user computer (20) is a digital jukebox (20) for which said predefined event (208) comprises payment of a user fee for a presentation of at least one said media element (32) on said digital jukebox.

15. The system (10) of claim 14, wherein said promotional media element descriptor (66) describes an artistic genre therefore.

16. The system (10) of claim 3, wherein, for each presentable advertisement 52, said business module (38) generates a respective selectable reference (238) to said respective promotional media element 32, each respective selectable reference (238) being presented on a selection screen (236) on said end-user computer (20) by said end-user interface (34), said promotional media element (32) being presented on said end-user computer (20) when said respective selectable reference (238) is selected on said end-user interface (34).

17. The system (10) of claim 16, wherein said end-user interface (34), based on said score (230), presents said respective selectable reference (238) with a respective degree of prominence (233) relative each other said respective selectable reference (238).

18. The system (10) of claim 6, wherein said business module (38) automatically reduces said respective audience bid (116) and said respective presentation bid (108) to a predefined excess amount over, respectively, a closest said audience bid (116) and a closest said respective audience bid (116) below said respective audience bid (116) and said respective presentation bid (108).

19. The system (10) of claim 1, wherein said business module (38), said advertisement (52), said respective advertisement parameter (66, 78, 92, 96, 100, 106, 108, 112, 114, 116, 172, 270, 280), and said respective promotional media element are stored on said end-user computer (20), said advertisement (52), said respective advertisement parameter (66, 78, 92, 96, 100, 106, 108, 112, 114, 116, 172, 270, 280), and said respective promotional media element (32) are stored on said end-user computer (20) being receivable and updatable from a back-end server (12) and a media provider (18) by connecting respectively to said back-end server (12) and to said media provider (18) over at least one network (22) using a dial-up connection.

20. The system 10 of claim 1, wherein said advertisement parameter (504) is a slot time (504) assigned to said advertisement (52) and corresponding to an available advertisement slot (500) on said end-user computer (20), said advertisement (52) being identified as said presentable advertisement (52) when said predefined event (204) occurs within said slot time (504) assigned thereto.

21. The system of claim 20, wherein said advertisement slot 500 is associated with an respective slot cost (506), said slot cost (506) being collected as a compensation when said respective media element (32) for said presentable advertisement (52) is presented on said end-user computer.

22. A method (200) for presenting digital media to an end-user for promotion thereof to the end user, the method comprising the steps of:
defining (202), from a promoter interface 26, at least one advertisement (52) having at least one respective advertisement parameter (66, 78, 92, 96, 100, 106, 108, 112, 114, 116, 172, 270, 280, 504), including a respective advertisement budget (106) therefor, and a respective promotional media element (32) associated therewith, said respective promotional media element (32) being a media element (32) of the digital media;
based on said at least one advertisement parameter (66, 78, 92, 96, 100, 106, 108, 112, 114, 116, 172, 270, 280, 504), identifying (206), in response to at least one predefined event, at least one said advertisement (52) as a presentable advertisement (52);
selectively presenting (246) on an end-user computer (20), through an end-user interface (34), said respective promotional media element (32) for said presentable advertisement (52) on said end-user computer (20);
and
collecting (250), in accordance with said respective advertisement budget (106) for said advertisement (52) for which said respective promotional media element (32) is presented, a compensation when said promotional media element (32) is presented on said end-user computer (20).

23. The method (200) of claim 22, wherein said predefined event (204) is at least one of a payment of a user fee by an end-user for use of said end-user computer (20) and expiration of a predefined idle period of idle time (272) in which said end-user computer (20) is idle.

24. The method (200) of claim 22, further comprising the steps of generating (228) a respective score (230) for each advertisement (52) based on said at least one said respective advertisement parameter (78, 92, 96, 106, 108, 112, 114, 116, 172, 270) and identifying (229) said presentable advertisement (52) based upon said respective score (230).

25. The method (200) of claim 24, further comprising the steps of displaying (242) a respective selectable reference (238) for each respective promotional media element (32) of each said presentable advertisement (52) on a selection screen (236) on said end-user computer (20) and receiving a selection (244) from said user of a selected said respective selectable reference (238), said step (246) of presenting said respective promotional media element (32) comprising presentation of said respective promotional media element (32) for said selected said respective selectable reference (238).

26. The method (200) of claim 25, wherein said respective selectable reference (238) is displayed with a respective degree of prominence (233) on said selection screen (236) relative each other said respective selectable reference (238), said respective degree of prominence being determined based on said respective score (230).

27. The method (200) of claim 22, further comprising the steps of submitting (222) said promotional media element (32) to said media provider (18) from said promoter interface (26) and formatting (219) said promotional media element (32) submitted into a media provider format (190) receivable by a media provider (18) from which said promotional media element (32) is provided to said end-user computer (20).

28. The method of claim 22, wherein said step of defining (202) said advertisement (52) comprises assigning a predefined advertisement slot 500 having a predefined slot time (506) for said end-user computer (20) to said advertisement (52) and said step of identifying (204) comprises designating said advertisement as said presentable advertisement (52) when said predetermined event (204) occurs on said end-user computer (20) within said predefined slot time (504).
